(19) United States
(12) Patent Application Publication
(10) Pub. No.: US 2005/0019471 A1
(43) Pub. Date: Jan. 27, 2005

(54) Whey protein emulsion

(75) Inventor: Chris Pernell, Cary, NC (US)

Correspondence Address: NOVOZYMES NORTH AMERICA, INC., 500 FIFTH AVENUE, SUITE 1600, NEW YORK, NY, 10110, US

(73) Assignee: Novozymes North America, Inc., Franklinton, NC (US)

(21) Appl. No.: 10/919,611

(22) Filed: Aug. 17, 2004

Related U.S. Application Data
(63) Continuation of application No. 09/636,453, filed on Aug. 11, 2000, now abandoned.

(51) Int. Cl. A23C 9/12

(52) U.S. Cl. 426/580

(57) ABSTRACT

The present invention provides methods and compositions for enhancing the incorporation of whey proteins into dairy products, which comprise forming a homogenate or emulsion comprising whey proteins and cream, and incorporating the homogenate or emulsion into dairy products. The invention also provides whey protein/cream emulsions and dairy products that incorporate such emulsions.

### CROSS-REFERENCE TO RELATED APPLICATIONS

This application is a continuation of U.S. application Ser. No. 09/636,453 filed Aug. 11, 2000, the contents of which are fully incorporated herein by reference.

### FIELD OF THE INVENTION

The present invention relates to methods for improving the incorporation of whey proteins into cheese and other dairy products.

### BACKGROUND OF THE INVENTION

Whey is a by-product of the production of cheese. Whey proteins comprise approximately 20% of the total protein in milk. Traditionally, whey is disposed of as unused waste or used as fertilizer or animal feed. However, efforts are currently directed towards processing whey into commercially useful products. The present invention is directed to methods for enhancing the incorporation of whey proteins into cheese and other dairy products.

Prior to the present invention, methods for incorporation of whey proteins into cheese were limited to concentration of milk by ultrafiltration or heat denaturation of milk or whey. However, inclusion of significant amounts of whey protein into cheese using either of these methods has a negative impact on the physical properties of the cheese. Fresh cheeses like mozzarella, for example, exhibit reduced stretch and meltability due to whey proteins (Bulletin of the International Dairy Federation N 240/1989), while ripened cheese, such as, e.g., cheddar, exhibit poor ripening (R. C. Lawrence, Bulletin of the International Dairy Federation 240: 1-15, 1989).

The present invention relates to the emulsification of whey proteins with cream to form a composition useful for supplementation of cheese and other dairy products.

The surface active properties of whey proteins have allowed their use as emulsifiers in vegetable oil-based emulsions (Huang et al., J. Agric. Food Chem. 44:3437, 1996; Agboola, et al; J. Agric. Food Chem.; 46:84, 1998; Singh et al., J. Dairy Sci. 81:918, 1998). Homogenates or emulsions of cream (using as emulsifiers sweet buttermilk, soy lecithin, fat replacers, and native casein micelles) have been used in the manufacture of low-fat cheese (Poduval et al., J. Dairy Sci. 82:1, 1999; Rudan et al., J. Dairy Sci.; 81:2077, 1998; Rudan et al., J. Dairy Sci. 81:2065, 1998;. Lelievre et al., J. Soc. Dairy Technol. 43:1, 1990. However, prior to the present invention, cream has not been used as a carrier to maximize the amount of whey that could be added to a dairy product.

Thus, there is a need in the art for methods and compositions that allow enhanced incorporation of whey proteins into cheese and other dairy products without negatively influencing the properties of the cheese.

### SUMMARY OF THE INVENTION

The present invention provides methods for producing a dairy product additive, which are carried out by subjecting a mixture of (i) cream and (ii) a whey protein preparation to a homogenization/emulsification process. The whey protein preparation includes, without limitation, a whey protein isolate (WPI) or a whey protein concentrate (WPC). In some embodiments, the whey protein preparation comprises hydrolyzed whey proteins, which are formed by proteolysis; most preferably, the protease used to hydrolyze the whey protein preparation has a limited substrate specificity, and the hydrolyzed whey protein preparation exhibits a limited degree of hydrolysis (DH), such as, e.g., between about 0.5 and 20%, preferably between about 1 and 10%, and most preferably between about 2 and 8%. In other embodiments, the hydrolyzed whey protein preparation exhibits a higher DH, such as, e.g., 30%, 40%, or 50%.

In some embodiments, the whey protein-cream mixture is contacted with a protease prior to, or after, the homogenization/emulsification step. In the former case, the protease may be inactivated prior to homogenization.

In another aspect, the invention provides a dairy product additive produced by homogenizing or emulsifying a mixture of whey protein and cream. In some embodiments, the additive comprises a whey protein:fat ratio of at least about 2% by weight, preferably at least about 4%, more preferably at least about 8% and most preferably at least about 12%.

In yet another aspect, the invention provides methods for producing a dairy product, which are carried out by:

(i) providing a mixture of (a) cream and (b) a whey protein preparation;

(ii) subjecting the mixture to a homogenization/emulsification process; and

(iii) incorporating the homogenized/emulsified mixture produced in (ii) into a dairy product.

Preferably, the mixture of step (i) contributes at least about 5% of the total fat in the dairy product, preferably at least about 20%, and more preferably at least about 40%. In some embodiments, the mixture of step (i) further comprises a phospholipase.

In yet another aspect, the invention encompasses dairy products comprising the dairy product additive of the invention and dairy products produced using the methods of the invention. Such products include, without limitation, cheese (including ripened and unripened cheese), yogurt, spreads, cream, and the like.

### DETAILED DESCRIPTION OF THE INVENTION

The present invention encompasses methods and compositions for enhancing the use of whey proteins in cheese or other dairy products by homogenizing a mixture of whey proteins and cream and incorporating the homogenate into a dairy product.

Increasing the amount of whey in dairy products by adding whey protein in the form of a cream emulsion reduces the negative effects observed when whey is added by other means, such as, e.g., by ultrafiltration of milk. Furthermore, addition of whey according to the invention offers the advantage that processing steps like ultrafiltration and heat denaturation can be avoided. The methods and compositions of the invention also increase the amount of cream fat that may be incorporated into cheese (fat yield).

As used herein, “homogenization” refers to any process that forms a fine dispersion of oil and water phases of a mixture, such as, e.g., a mixture of whey proteins and cream. “Emulsification” refers to a homogenization process that forms a stable suspension of droplets and/or increases the amount or whey proteins or peptides derived therefrom that are bound to the fat so that the whey proteins follow the fat phase if the fat phase is separated from the water phase. Preferably, the methods of the invention result in the formation of an emulsion comprising whey proteins and cream.

The whey protein/cream homogenates/emulsions formed according to the invention find use in a variety of dairy products in which a high concentration of whey protein is desired, including, without limitation, cheese (including ripened and unripened cheese), yogurt, spreads, creams, and the like.

Whey Proteins

Whey proteins for use in the present invention may be obtained by any method known in the art. Typically, whey proteins are recovered by one or more of ultrafiltration, electrodialysis, evaporation, or reverse osmosis of cheese whey. See, e.g., U.S. Pat. No. 3,547,900; and Horton et al., Food Technol. 26:30, 1972. Whey derived from any cheese process, including cheese production by the use of rennet, acidification, or concentration of casein by filtration may be used, and the whey from any cheese source may be used, including, e.g., cheddar cheese, Swiss cheese, mozzarella cheese, and the like.

Whey protein preparations, which typically contain beta-lactoglobulin and/or alpha-lactalbumin, are commercially available as whey protein concentrates (WPC) or whey protein isolates (WPI), from, e.g., Davisco (Le Sueur Minn.); Bio-lsolates PLC (Deeside, UK); NZMP North America (Santa Rosa Calif.); Formost Farms (Baraboo Wis.); and MD Foods (Union N.J.). WPI preparations typically contain less than 0.5-1% fat by weight. WPC preparations typically contain more than 3% fat, while WPC that have been subjected to additional processing steps such as, e.g., microfiltration, ion exchange, or heat treatment may have less fat.

Cream

The cream component used in forming the homogenates/emulsions of the present invention may be any lipid-containing preparation or composition in which the casein:lipid ratio is less than about 0.5 on a weight to weight basis, including, without limitation, cream made by fractionation of milk into a lipid-rich fraction and a less lipid-rich fraction. The lipid-rich cream fraction typically contains more than 10% fat, most typically about 30-40% fat. The cream component used for the present invention may be diluted, concentrated, or dried from such a lipid-rich milk fraction. 30-40% fat creams made from milk typically contain about 0.5% w/w whey proteins and about 1.7% w/w casein; resulting in a whey protein:fat ratio of about 1.2-1.9% and a casein:fat ratio of about 5-10%.

Cream for use in the present invention may be derived from any lipid containing source, such as, e.g., milk, including, without limitation, cow, goat, and sheep milk.

Homogenization/Emulsification of Whey Proteins and Cream

The present invention provides methods for producing a dairy product additive, which are carried out by subjecting a mixture of cream and whey proteins to a homogenization process.

Typically, a mixture is formed between cream and a whey protein preparation at a whey protein:fat ratio of at least about 2% (w/w of protein to fat), preferably at least about 4%, more preferably above about 8%, and most preferably above about 12%. In a cream containing 30% fat (i.e., 30 g fat/100 g cream), for example, the invention provides mixtures containing at least about 0.6 g whey protein/100 g cream, preferably at least about 1.2 g whey protein/100 g cream; more preferably at least about 2.4 g whey protein/100 g cream, and most preferably at least about 4.8 g whey protein/100 g cream.

The whey protein:cream mixture is then subjected to a homogenization process, preferably an emulsification process. Any method of mechanical agitation producing high shear forces may be used for homogenization, including, but not limited to, the use of high pressure dairy homogenizers, rotary blenders, sonicators, or any device that imparts rapid, intensive pressure fluctuations occurring in turbulent flow.

Whey Protein Hydrolysis:

In some embodiments, the whey protein preparation used in forming the homogenate or emulsion of the invention is subjected to proteolysis, either before or after being contacted with the cream and preferably before the homogenate or emulsion is formed.

In one series of embodiments, the proteolyzed whey protein preparation exhibits a limited degree of hydrolysis (DH). The degree of hydrolysis is preferably between about 0.5% and 20%, more preferably between about 1% and 10%, and most preferably between about 2% and 8%. In another series of embodiments, the proteolyzed whey protein preparation exhibits a higher DH, such as, e.g., at least about 30%, 40%, or 50%. DH may be measured using any method known in the art, including, without limitation, measuring free amino groups using the OPA (o-phthaldialdehyde) method (Church et al., Anal. Biochem. 146:343, 1985) (see, e.g., Example 1 below) and comparing amino nitrogen/total nitrogen; measuring a decrease in pH; measuring an increase in osmolality; and the like.

Proteases:

Any protease that digests whey proteins may be used, including, without limitation, a serine protease, a metalloprotease, or an aspartyl protease. Non-limiting examples of useful proteases are subtilisins, such as, e.g., subtilisin PB92 (Maxacal®, Gist-Brocades NV), subtilisin 309 (Savinase®, Novo Nordisk), Durazym®, and subtilisin 147 (Esperase®, Novo Nordisk); Alcalase®, and Rennilase®. Other preferred serine-proteases are disclosed in, e.g., WO 88/03947, WO 91/00345, and EP 415 296. Useful metalloproteases include, without limitation, Neutrase® (Novo Nordisk). Other useful proteases include, without limitation, Bactosol® WO and Bactosol® SI (Sandoz AG); Toyozyme® (Toyo Boseki Co. Ltd., Japan); and Proteinase K® (Kao Corporation Ltd., Japan), and Trypsin (PTN from Novo Nordisk) or any other Iys/arg- or lys-specific protease.

In some embodiments, treatment with a glu/asp-specific protease is used to produce a hydrolyzed whey protein preparation. As used herein, a glu/asp-specific protease refers to a protease that hydrolyzes peptide bonds on the carboxyterminal side of glutamic acid and aspartic acid residues. As used herein, a purified glu/asp-specific protease preparation refers to a preparation that lacks significant non-glu/asp-specific proteolytic activity; typically, the non-glu/asp-specific proteolytic activity (measured as AU) is present at a specific activity level less than about 40%, preferably less than about 20%, and more preferably less than about 5%, of the specific activity of the glu/asp-specific component, when compared using conventional specific activity units.

Glu/asp-specific proteases useful in practicing the present invention include, without limitation, Staphylococcus aureus V8 protease (Chobert et al J. Agric. Food. Chem. 36:220, 1988) and glu/asp-specific proteases derived from Bacillus species, including, without limitation, Bacillus licheniformis, Bacillus subtilis, and Bacillus pumilis. In one series of embodiments, a B. licheniformis enzyme is utilized, such as, e.g., that disclosed in U.S. Pat. No. 5,866,357.

In some embodiments, a mixture of two enzymes is used, preferably a mixture of a glu/asp-specific protease and another non-glu/asp-specific protease, most preferably a mixture of a glu/asp-specific protease and a protease having specificity for lys or lys/arg residues.

Proteases for use in the present invention comprise wild-type or mutant enzymes. The enzymes may be isolated from their cell of origin or may be recombinantly produced using conventional methods well-known in the art.

Methods for Hydrolyzing Whey Proteins:

In some embodiments, the whey protein is subjected to proteolysis prior to being contacted with the cream.

For this purpose, an aqueous solution is prepared containing whey protein, preferably a whey protein isolate or whey protein concentrate, at a concentration corresponding to between about 0.5% and about 40% w/w protein, preferably between about 5% and about 30%, more preferably between about 10-20%, and most preferably about 12-15%. The pH of the solution should be between about 5 and about 8, preferably between about 6.0 and about 7.8, and most preferably about 6.5-7.0. Any compatible buffer system may be used.

A reaction mixture is formed by adding to the aqueous protein-containing solution a protease, preferably a glu/asp-specific protease and most preferably a protease homologous to B. licheniformis glu/asp-specific protease, at a ratio of between about 0.1-5% w/w protease:substrate protein for a 4 h incubation; preferably between about 0.2-2.5%, and most preferably between about 0.5-1%. In other embodiments, the protease is added at a ratio of between about 0.1-500 mAU/g substrate protein for a 4 h incubation, preferably 1-50 mAU/g, more preferably 10-25 mAU/g. One AU (Anson unit) is defined as the amount of enzyme that digests denatured hemoglobin at 25° C., pH 7.5 in 10 min, at an initial rate that liberates an amount of trichloroacetic acid-soluble material that is equivalent to one milliequivalent of tyrosine, when measured by color production using a phenol reagent.

The reaction mixture is incubated at a temperature of between about 20-75° C., preferably between about 30-65° C., more preferably about 50° C., until a desired degree of hydrolysis (DH) is achieved.

It will be understood that each of the reaction conditions (such as, e.g., concentration of the whey protein preparation, ratio of enzyme:substrate, pH, temperature, and time) may be varied, depending upon, e.g., the source of the whey protein and/or enzyme and the final use for which the whey protein hydrolysate is intended. It will further be understood that optimization of the reaction conditions may be achieved using routine experimentation by establishing a matrix of conditions and testing different points in the matrix. For example, a hydrolysis time between 15 min and 24 hours may be used and the enzyme concentration may be adjusted accordingly.

In one series of embodiments, a whey protein preparation is hydrolyzed with a glu/asp specific protease at a concentration of between about 10-25 mAU/g protein for 4 h. Such a procedure results in the production of a mixture of amphoteric peptides derived from the whey, which are capable of being integrated into a cream emulsion at relatively high concentrations. Furthermore, the emulsified product exhibits a high water-binding activity and promotes a strong interaction between fat and proteins when used in dairy products, resulting in, e.g. a low oiling-off in mozzarella cheese.

In some embodiments, the methods of the invention encompass an additional step of inactivating or removing the protease. Inactivation may be achieved by any method known in the art, including, without limitation, increasing the temperature of the reaction mixture to above inactivation temperature of the enzyme. The inactivation temperature may vary, depending on the enzyme, the whey concentration, the time and the pH. When Bacillus licheniformis glu/asp-specific protease is used in reaction mixtures containing more than 5% whey protein at pH 7, treatment at 70° C. or higher is required to inactivate the protease. Lower temperatures may be used at lower pH values. Furthermore, increasing the pressure to above about 6000 bar also may be used, or any other method known in the art. Removal of the protease may be achieved by, e.g., filtration or immobilization, including the use of immobilized enzymes. Inactivation or removal of the protease is monitored by testing residual proteolytic activity, using any method known in the art.

In some embodiments, the methods of the invention encompass one or more additional steps of processing the hydrolyzed protein by, e.g., fractionation, drying, including spray-drying and freeze-drying; and concentrating, which can be achieved using, e.g., evaporation or membrane filtration.

In other embodiments, the mixture of whey protein preparation and cream is contacted with a protease prior to homogenization/emulsification.

Additional Components:

In practicing the present invention, treatment with phopholipases, including, without limitation, phospholipase A1, A2, B, C and D, can be used in combination with the emulsification of the whey protein into cream. Such treatment can be used to further alter the properties of the cream and thereby enhance the benefits of whey addition via emulsification of whey into cream.

Phospholipases for use in the present invention include, without limitation, mammalian phospholipases, such as, e.g. those derived from bovine or porcine pancreas, or phospholipases derived rom snake venom or bee venom. Alternatively, the phospholipase may be of microbial origin, e.g. from filamentous fungi, yeast or bacteria. One useful phospholipase is derived from strain of Fusarium, particularly F. oxysporum, e.g. from strain DSM 2627 as described in WO 98/26057, especially described in claim 36 and SEQ ID NO: 2 of WO 98/26057. In further embodiments, the phospholipase is a phospholipase as disclosed in PCT/DK/0066.

Phospholipases for use in the present invention may comprise wild-type or mutant enzymes. The enzymes may be isolated from their cell of origin or may be recombinantly produced using conventional methods well-known in the art.

Production of Dairy Products:

The present invention also encompasses methods for producing dairy products and dairy products produced using these methods. The methods are carried out by incorporating the whey protein-cream homogenate or emulsion described above into a dairy product. Dairy products into which the homogenate or emulsion may be incorporated include, without limitation, cheese (both ripened and unripened cheese), yogurt, spreads including butter, and cream. As used herein, “incorporation” refers to any process known in the art for preparation of a dairy product.

For cheese or yogurt production, the fat content of the milk before renneting or acidification is often adjusted to a specific value, typically between 2-14%, such as, e.g., 3.5% for cheddar. A particular fat content may be obtained by combining milk, cream, skim milk and skim milk powder. The emulsified cream according to the invention will typically contribute more than about 5%, preferably more than about 20%, and more preferably more than about 40% of the total amount of fat in the dairy product.

For most cheeses, the emulsified cream is typically added before or simultaneous with the addition of rennet or before rennet-induced coagulation. For cream cheese, the emulsified cream is added before or simultaneous with rennetting/acidification and/or the emulsified cream is mixed into the curd after the curd is formed (especially in the “hot pack” types which are subjected to further homogenization prior to packaging). For processed cheese, the emulsified cream may be added at several stages, such as, e.g., mixed with other ingredients before cooking, or added before or simultaneous with rennet to ultrafiltered cheese, if such cheese is used as a ingredient in the cream cheese. For yogurt, the emulsified cream is typically added before or simultaneous with the addition of starter cultures.

The methods of the present invention result in the production of dairy products that contain significantly higher levels of whey protein than conventional dairy products. For example, dairy products produced using the methods of the invention contain at least about 1% whey protein by weight of the product, preferably at least about 2%, more preferably at least about 4%. In another aspect, the whey protein in dairy products produced using the methods of the invention comprises at least about 3% by weight of the total protein in the product, preferably at least about 5%, more preferably at least about 10%, and most preferably at least about 15%. In preferred embodiments, cheese produced using the methods of the invention comprises significantly higher amounts of whey protein without exhibiting reduced stretchability or meltability or impaired ripening that would be expected to result from the added whey. Furthermore, cheese produced (“oiling-off”) using the methods of the invention preferably exhibits decreased free oil release relative to the free oil release of a cheese produced in an identical manner but without the whey protein/cream homogenate of the invention.

The following examples are intended as non-limiting illustrations of the present invention.

### EXAMPLE 1

### Proteolysis of Whey Protein

The following experiment is performed to subject whey proteins to limited hydrolysis under specified conditions.

Methods:

Whey protein solutions containing 20% solids were reconstituted from WPC (Davisco HiPro WPC 80%) and WPI (Davisco BiPro WPI 90%), and were treated in the absence or presence of B. licheniformis glu/asp-specific protease at an enzyme-to-substrate ratio of 14 mAU/g at 50° C. for 240-300 minutes at pH 7.0. The reaction mixtures were then spray dried.

The hydrolysates were analyzed for DH by OPA as follows: The OPA reagent was prepared by dissolving 7.620 g di-sodium tetraborate decahydrate (Aldrich 22,133-3) and 200 mg sodium dodecyl sulphate (Sigma L-3771) in 150 ml water. 160 mg o-phthaldialdehyde 97% (Sigma P-0657) was dissolved in 4 ml ethanol and added to the mixture, after which 176 mg dithiothreitol 99% (Sigma D-9163) was added and the mixture was brought to 200 ml with deionized water.3 ml OPA reagent was added to a test tube, after which 400 microliters serine standard or sample was added. After mixing, the mixtures were incubated for exactly 2 minutes, after which absorbance at 340 nm was measured. DH was calculated using the following formulas:
Serine NH₂=(ODₛₐₘₚₗₑ−OD_{blank})/(OD_{standard}−OD_{blank})*0.9516 meqv/l*(0.1*100 l/g protein)/(X*P) a.

Serine NH₂=meqv serine NH₂/g protein

X=g sample

P=% protein in sample

0.1=sample volume in liters

h=(Serine-NH₂—beta)/alpha meqv/g protein
DH=h/hₜₒₜ* 100% b.
Results:

The method described above resulted in hydrolysis of WPI to a DH of 7.3% and hydrolysis of WPC to a DH of 6.7%.

### EXAMPLE 2

### Production of Dairy Products that Incorporate a Whey Protein/Cream Emulsion

The following experiment was performed to test the effect of inclusion in cheese of the dairy product additive of the invention on the properties of the cheese.

I. Methods:

A. Whey Protein Hydrolysis:

A whey protein solution containing 5% protein was reconstituted from 80% WPC (Davisco HiPro WPC 80%). The pH of the solution was adjusted to 6.5 and the solution was placed at 50° C. B. licheniformis glu/asp-specific protease was then added at an enzyme:substrate ratio of 0, 7.5, and 250 AU/kg protein and incubated for 1 h at 50° C. The reaction mixture was then incubated at 75° C. for 3 h to inactivate the enzyme, after which the samples were freeze dried.

B. Cheese Production:

Hydrolyzed and unhydrolyzed whey protein preparations were added to 30% cream to a final concentration of 4% protein by weight, and the mixtures were homogenized using a hand-held homogenizer (Polysciencies Model X-5-20) for 0.5 min at speed 1.

The homogenized mixture was then mixed with pasteurized skim milk to provide a cheese milk containing 3.5% fat. The milk was equilibrated to 35° C. and a starter culture was added. 40 ml of a starter culture solution (formed by dissolving 0.18 grams each of LH100 and TA061 (Rhodia, Madison Wis.) in 250 ml skim milk and incubating at 35° C. for 30 minutes) were added per 1 of the cheese milk. The mixture was gently agitated for about 15 min until a pH of 6.4 was reached. Then, rennet (acid aspartic Rhizomucor miehei protease, 2 KRU/L milk) was added, and the milk was stirred for 3 minutes. Subsequently the milk was allowed to stand for about 35 minutes before cutting. The cheese was then drained for one hour at 41° C. using a funnel and cheesecloth and the whey was recovered. When the curd reached a pH of 5.3, it was flooded in a bucket in a water bath at 57° C. for 5 minutes. The cheeses were hand stretched and replaced in a water bath when necessary to return the cheese to 57° C. The cheeses were tempered in cold water for 10-15 minutes, and refrigerated overnight.

C. Analysis:

The protein content of the cheese was measured using the Dumas Combustion Method in a LECO apparatus. The moisture content was measured using a CEM Automatic Volatility Computer, Model AVC-80 (CEM Corp., Matthews, N.C.). Whey protein was measured using the Bio-Rad protein reagent, using whey protein to generate a standard curve.

Meltability was measured by (i) grinding the cheese samples in a blender for 20 seconds; (ii) molding 3 g of the ground cheese into a 2.2 cm metal ring and (iii) placing the ring in the center of a glass petri dish. The cheese samples were then heated in an oven at 100° C. for 14 minutes. The area taken up by the cheese was measured before and after melting. Meltability was calculated as follows:

$$Meltability = \frac{Area After Melt - Area Before Melt}{Area Before Melt} \times 100$$

Meltability was normalized to the meltability of a control cheese and expressed as a percentage of the control meltability.

II. Results

The results are presented in the Table below.

| | No | | Hydrolyzed | Hydrolyzed |
|---|---|---|---|---|
| | added | Whey | Whey | Whey |
| | whey | (no hydrolysis) | (7.5 AU/kg) | (250 AU/kg) |
| Protein in cheese | 14.8 | n.d. | 17.9 | 19.2 |
| (% by wt) | | | | |
| Protein in recovered | 7.3 | 10.6 | 7.8 | 8.1 |
| whey (mg/ml) | | | | |
| Moisture (%) | 53.7 | 56.2 | 58.5 | 58.3 |
| Meltability | 100 | 90 | 100 | 109% |

The results indicate that supplementation of a cheese milk with a whey protein/cheese emulsion resulted in enhanced incorporation of whey protein into the cheese, particularly when the whey protein used to make the emulsion had undergone proteolytic digestion prior to emulsification. This is reflected in the observation that the supplemental whey protein is not recovered in the whey that is formed as a result of the cheese-making process but rather remains in the cheese.

Furthermore, there is a detectable increase in the moisture content of the cheese as a result of the supplementation with whey protein. Finally, use of hydrolyzed whey protein in the methods of the invention reverses a decrease in meltability resulting from whey protein supplementation.

All patents, patent applications, and literature references referred to herein are hereby incorporated by reference in their entirety.

Many variations of the present invention will suggest themselves to those skilled in the art in light of the above detailed description. Such obvious variations are within the full intended scope of the appended claims.

1-31. (Cancelled)

32. A method for producing cheese, said method comprising
(a) subjecting a mixture of (i) cream and (ii) a whey protein preparation to a homogenization process; wherein said whey protein preparation comprises hydrolyzed whey proteins;
(b) mixing said homogenized mixture from said a) with a milk to provide a cheese milk; and
(c) producing cheese from said cheese milk, wherein said cheese has improved meltability compared to cheese made using an unhydrolyzed whey protein preparation.

33. A method as defined in claim 32, wherein said homogenization process comprises emulsification.

34. A method a defined in claim 32, wherein said whey protein preparation is selected from the group consisting of whey protein isolate and whey protein concentrate.

35. A method as defined in claim 32, wherein said whey protein preparation exhibits a degree of hydrolysis (DH) of between about 0.5% and about 20%.

36. A method as defined in claim 35, wherein said whey protein preparation exhibits a degree of hydrolysis (DH) of between about 1 % and about 10%.

37. A method a defined in claim 36, wherein said whey protein preparation exhibits a degree of hydrolysis (DH) of between about 2% and about 8%.

38. A method as defined in claim 32, wherein said hydrolyzed whey proteins are prepared by contacting whey proteins with a glu/asp-specific protease.

39. A method as defined in claim 32, wherein the mixture is contacted with a protease prior to said homogenization step.

40. A method as defined in claim 39, further comprising inactivating said protease prior to said homogenization step.

41. A cheese product produced using a method as defined in claim 32.

42. The method as defined in claim 32, wherein said homogenized mixture comprises a whey protein:fat ratio of at least about 2% by weight.

43. The method as defined in claim 32, wherein said homogenized mixture comprises a whey protein:fat ratio of at least about 4% by weight.

44. The method as defined in claim 32, wherein said homogenized mixture comprises a whey protein:fat ratio of at least about 8% by weight.

45. The method as defined in claim 32, wherein said homogenized mixture comprises a whey protein:fat ratio of at least about 12% by weight.

46. The method of claim 32, wherein the hydrolyzed whey protein preparation was prepared by treating the whey proteins with a protease in a ratio of between about 0.1-5% w/w protease:whey protein.

47. The method of claim 32, wherein the hydrolyzed whey protein preparation was prepared by treating the whey proteins with a protease in a ratio of between about 0.5-1 % w/w protease:whey protein.

48. The method of claim 32, wherein the hydrolyzed whey protein preparation was prepared by treating the whey proteins with a protease in a ratio of between about 0.1-500 mAU/g whey protein.

49. The method of claim 32, wherein the hydrolyzed whey protein preparation was prepared by treating the whey proteins with a protease in a ratio of between about 1-50 mAU/g whey protein.

50. The method of claim 32, wherein the hydrolyzed whey protein preparation was prepared by treating the whey proteins with a protease in a ratio of between about 10-25 mAU/g whey protein.

51. A method for producing cheese, said method comprising:
(a) providing a mixture comprising (a) cream and (b) a whey protein preparation; wherein said whey protein preparation comprises hydrolyzed whey proteins;
(b) subjecting the mixture to a homogenization process; and
(c) incorporating the homogenized mixture produced in (ii) into cheese wherein said cheese has improved meltability compared to cheese made using an unhydrolyzed whey protein preparation.

52. A method as defined in claim 51, wherein said homogenization process comprises emulsification.

53. A method as defined in claim 51, wherein said whey protein preparation is selected from the group consisting of whey protein isolate and whey protein concentrate.

54. A method as defined in claim 51, wherein said hydrolyzed whey proteins are prepared by contacting whey proteins with a glu/asp-specific protease.

55. A method as defined in claim 51, wherein the mixture of step (a) contributes more than about 5% of the total fat in the cheese.

56. A method as defined in claim 55, wherein the mixture of step (a) contributes more than about 20% of the total fat in the cheese.

57. A method as defined in claim 56, wherein the mixture of step (a) contributes more than about 40% of the total fat in the cheese.

58. A method as defined in claim 51, wherein the mixture of step (a) is contacted with a protease prior to step (b).

59. A method as defined in claim 58, wherein the protease is inactivated prior to step (b) or step (c).

60. A method as defined in claim 51, wherein the mixture of step (a) further comprises a phospholipase.

61. A method as defined in claim 51, wherein said cheese is selected from the group consisting of ripened and unripened cheese.

62. A method as defined in claim 61, wherein said ripened cheese is cheddar and said unripened cheese is mozzarella or cream cheese.

63. A cheese product produced by a method as defined in claim 51.

64. The method of claim 51, wherein the hydrolyzed whey protein preparation was prepared by treating the whey proteins with a protease in a ratio of between about 0.1-5% w/w protease:whey protein.

65. The method of claim 51, wherein the hydrolyzed whey protein preparation was prepared by treating the whey proteins with a protease in a ratio of between about 0.5-1 % w/w protease:whey protein.

66. The method of claim 51, wherein the hydrolyzed whey protein preparation was prepared by treating the whey proteins with a protease in a ratio of between about 0.1-500 mAU/g whey protein.

67. The method of claim 51, wherein the hydrolyzed whey protein preparation was prepared by treating the whey proteins with a protease in a ratio of between about 1-50 mAU/g whey protein.

68. The method of claim 51, wherein the hydrolyzed whey protein preparation was prepared by treating the whey proteins with a protease in a ratio of between about 10-25 mAU/g whey protein.

69. A method for producing cheese, said method comprising
(a) preparing a hydrolyzed whey protein preparation by treating whey proteins with a protease in an amount about 0.1-5% w/w protease:whey protein;
(b) subjecting a mixture of (i) cream and (ii) the hydrolyzed whey protein preparation to a homogenization process;
(c) mixing said homogenized mixture from said a) with a milk to provide a cheese milk; and
(d) producing cheese from said cheese milk, wherein said cheese has improved meltability compared to cheese made using an unhydrolyzed whey protein preparation.

70. The method of claim 69, wherein the hydrolyzed whey protein preparation was prepared by treating the whey proteins with a protease in a ratio of between about 0.5-1%. w/w protease:whey protein.

71. A method for producing cheese, said method comprising
(a) preparing a hydrolyzed whey protein preparation by treating whey proteins with a protease in an amount about 0.1-500 mAU/g whey protein;
(b) subjecting a mixture of (i) cream and (ii) the hydrolyzed whey protein preparation to a homogenization process;
(c) mixing said homogenized mixture from said a) with a milk to provide a cheese milk; and
(d) producing cheese from said cheese milk, wherein said cheese has improved meltability compared to cheese made using an unhydrolyzed whey protein preparation.

72. The method of claim 71, wherein the hydrolyzed whey protein preparation was prepared by treating the whey proteins with a protease in a ratio of between about 1-50 mAU/g whey protein.

73. The method of claim 71, wherein the hydrolyzed whey protein preparation was prepared by treating the whey proteins with a protease in a ratio of between about 10-25 mAU/g whey protein
